(19) United States
(12) Patent Application Publication
(10) Pub. No.: US 2010/0157579 A1
(43) Pub. Date: Jun. 24, 2010

(54) BEVERAGE CONTAINER ILLUMINATION DEVICE

(76) Inventor: Artem A. Kononuk, Santa Rosa, CA (US)

Correspondence Address: DERGOSITS & NOAH LLP, Suite 1450, Four Embarcadero Center, San Francisco, CA, 94111, US

(21) Appl. No.: 12/337,766

(22) Filed: Dec. 18, 2008

(51) Int. Cl. F21V 33/00

(52) U.S. Cl. 362/101

(57) ABSTRACT

A device for illuminating a beverage container, the beverage container having a substantially transparent side wall, a base and an indent configured within the base. The device includes a light source and, a power supply for activating the light source, the device sized to reside within the indent or upon a support surface to which the base is applied. The device causes the indent to be illuminated to such an extent that the illumination is visible through the substantially transparent side wall of the beverage container.

### TECHNICAL FIELD

The present invention involves a device for illuminating a substantially transparent beverage container, such as a wine bottle for a variety of purposes. These include the ability to transform such containers to fanciful displays as well as for the functionally of being able to differentiate beverage containers in low light commercial settings.

### BACKGROUND OF THE INVENTION

Both domestically and commercially, one can often times find beverage containers either displayed singly or in rows and columns. Many of such containers are configured from either clear or substantially translucent glass or plastic having a base which includes an indent. Certainly virtually all 750 ml wine bottles are configured from clear, transparent or semi-transparent glass, or plastic having such an indent. It has been recognized that there would be certain distinct advantages in providing a device to selectively illuminate such containers for a variety of reasons.

Domestically, it is quite common to display wine bottles and other beverage containers at a bar or on a counter. Such containers house beverages oftentimes of different colors and transparencies. By incorporating the present invention, one is able to transform such containers into fanciful displays with little or no effort.

Commercially, bars and similar high volume dispensing stations oftentimes operate in low light conditions requiring a worker to be able to grab and dispense a beverage quickly and efficiently. By selectively illuminating such containers, the ability to identify them selectively is greatly enhanced. Further, the ability to illuminate such containers to again create fanciful displays provides obvious commercial appeal.

It is thus an object of the present invention to provide a device enabling one to convert common beverage containers to create fanciful displays selectively and at low cost.

It is yet a further object of the present invention to enable one to clearly differentiate beverage containers by selectively illuminating them or by providing certain characteristic light sources to assist a vendor, particularly in an industrial or commercial operation.

These and further objects will be more readily apparent in considering the following disclosure and appended claims.

### SUMMARY OF THE INVENTION

A device for illuminating a beverage container, the beverage container having a substantially transparent side wall, a base and an indent configured within the base. The device includes a light source and, a power supply for activating the light source, the device sized to reside within the indent or upon a support surface to which the base is applied. The device causes the indent to be illuminated to such an extent that the illumination is visible through the substantially transparent side wall of the beverage container.

### BRIEF DESCRIPTION OF THE FIGURES

FIG. 1 is a perspective view of the illumination device of the present invention.

FIGS. 2A and 2B are cross sectional views taken along 2-2 of FIG. 1 as alternative embodiments to the illumination device of the present invention.

FIG. 3 is a perspective view of yet a further embodiment of the illumination device of the present invention.

FIG. 4 is a side plan view of a typical beverage container display embodying the illumination device of the present invention.

FIG. 5 is a perspective view of yet another embodiment of the present invention.

FIG. 6 is a side view of a further embodiment of this invention implanted in an indent of a beverage container.

### DETAILED DESCRIPTION OF THE INVENTION

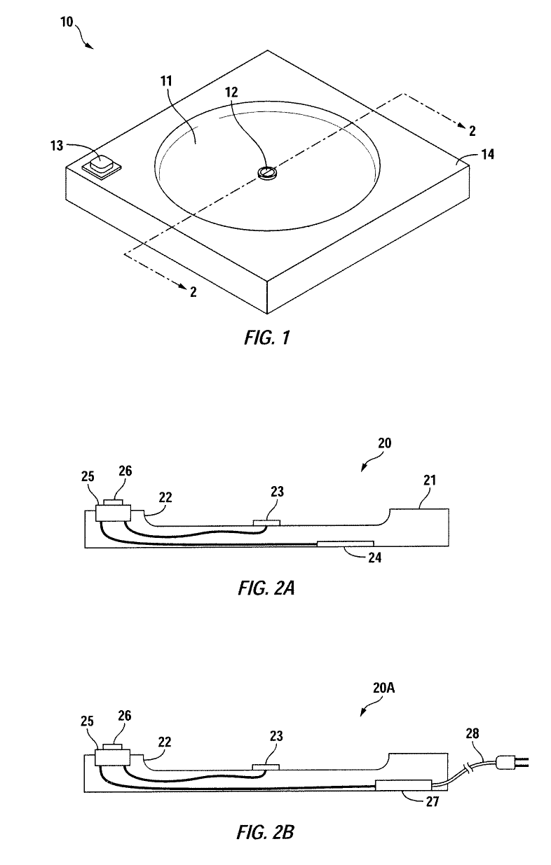

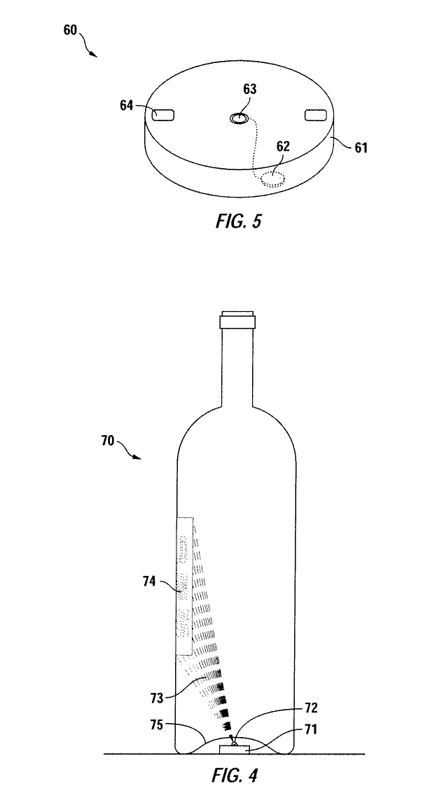

Turning first to FIG. 1, device 10 is shown for illuminating a beverage container, such as that depicted in FIG. 4. Typically, such beverage containers include a base 49/59 and indent 42/51 configured within base 49/59.

Turning again to FIG. 1, in a first embodiment, the present device comprises light source 12, most preferably an LED and power supply 24/27 (FIGS. 2A and 2B). In this first embodiment, base 14/21 is provided with depressed region 11/22 to which typical beverage container 40/45 can nest positioning light source 12/23 within indented portion 42/51 so that light emanating from this light source will pass within beverage container 40/45 and be visible to an observer by virtue of the beverage container having substantially transparent side walls 41/48. It should be noted that the present invention can be employed with any beverage container as long as light emitted by light source 12/23 can be made visible to an observer. For example, “transparent” side walls are intended to embrace an aluminum can having a cut out portion in its side walls and having a plastic liner to contain the beverage.

In turning to FIGS. 2A and 2B, it is noted that light source 23 can be powered by stand alone battery 24, ideally in the form of a “button” cell. Alternatively, power source 27 can be rechargeable by virtue of the use of AC power cord 28 or can be bypassed by providing suitable AC current directly to light source 23 or circuit board 25. These various iterations of the present invention are certainly well known to those of ordinary skill in the portable lighting art.

It is contemplated that light source 23 can remain dormant by blocking current from power source 24 while in storage or on sale by providing a simple insulating barrier or membrane as is common in the portable lighting industry. Once the membrane is removed, power is established to light source 23 from battery 24 so that light source 23 will remain illuminated until battery 24 is dissipated. Alternatively, base 21 can be provided with circuit board 25 having switch 26 provided thereon. Switch 26 can be a simple “on/off” switch to extend the battery life of the present device. In addition, switch 26 can be a three position switch having both “on/off” as well as “flashing” functions. As such, different illumination devices can be made to stay constantly “on” or “flash” to accomplish the goals of the present invention.

It is fully noted that LED 12 and LED 23 as well as LEDs 44 and 53 can illuminate light of the same or singular frequency or can be made to emit light of different frequencies in order to enhance the fanciful displays created thereby as well as to enable one to differentiate beverage containers in both domestic and commercial settings.

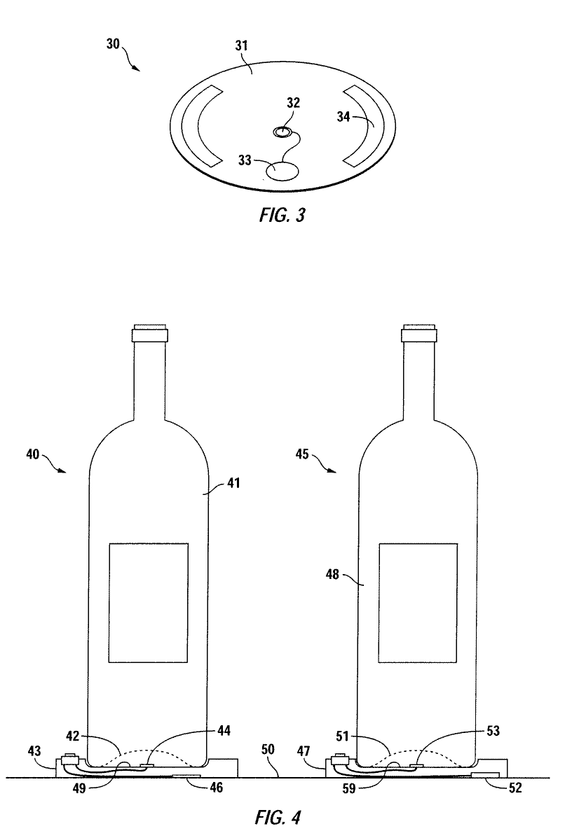

In addition to providing platforms 14/21/43/47, each configured to house said light source and power supply to support beverage containers 40/45 therein, an alternative embodiment are contemplated such as that shown in FIG. 3.

In turning to FIG. 3, it is noted that device 30 can take the form of a thin film 31 having a thin film LED 32 and thin film battery 33 contained thereon. By providing adhesive strips 34, device 30 can be pressed within indents 42/51 to reside entirely therein. Thus, when employing the embodiment of FIG. 3, even when beverage containers 40/45 are removed from shelf 50, light emitted from light source 32 remains with the container so that illumination of it is not interrupted.

From the above description, the benefits in practicing the present invention should become quite apparent. In a domestic setting, one wishing to add a festive appearance to one's bar area can align one or more beverage containers, such as wine bottles on a shelf and by employing the illumination device suggested herein, illuminate the containers at will. The containers can be illuminated constantly or, can display an intermittent or “flashed” source at the discretion of a user. In a dimly lit bar area, a bartender can employ the present invention to enable he or she to grab from a plurality of beverage containers to enable the correct container to fill an order simply by associating the appropriate container with a distinguishing light source. Bars can also employ the present invention for creating fanciful displays as many bars align a plurality of such containers in front of mirrored back drops which would represent an ideal setting for employing this invention.

As a further iteration, reference is made to FIG. 5. In this instance, device 60 is shown as a stand alone base 61 having battery 62 and LED 63 embedded therein. Device 60 can simply be placed within the indent to a beverage container or adhesive dot 64 can cause device 60 to adhere to the underside of the indent to remain with the beverage container whether the beverage container remains upon a shelf or is removed from it. In other words, device 60 is not intended to act as a support for the beverage container but is intended to reside beneath it completely within the indented portion of the base of the beverage container.

In turning to FIG. 6, yet a further embodiment of this invention is depicted. In this instance, beverage container 70 is shown within indent 75. Device 71 is contained therein in the form of, for example, a device similar to that depicted in FIG. 5. In this instance, lens 72 is placed upon the LED causing light emanating therefrom to project in the direction of beams 73 for applying a focused beam to area 74 in the side wall of beverage container 70. This creates a further fanciful display at the option of a user.

What is claimed is:

1. A device for illuminating a beverage container, said beverage container having a substantially transparent side wall, a base and indent configured within said base, said device comprising a light source and power supply for activating said light source, said device sized to reside on or in said base, said light source causing said indent to be illuminated to such an extent that said illumination is visible through said substantially transparent side wall.

2. The device of claim 1 further comprising a platform configured to house said light source and power supply and to support said beverage container by receiving said base.

3. The device of claim 1 wherein said light source and power supply are sized to reside entirely within said indent.

4. The device of claim 3 further comprising an adhesive for retaining said device within said indent.

5. The device of claim 1 wherein said power supply comprises a battery.

6. The device of claim 1 wherein said power supply comprises an AC source.

7. The device of claim 1 wherein said light source is in constant illumination when connected to said power supply.

8. The device of claim 1 wherein said light source pulses when connected to said power supply.

9. The device of claim 1 wherein a plurality of said devices are provided to a plurality of beverage containers.

10. The device of claim 9 wherein each of said plurality of devices comprise light sources that emit different colors from other of said devices.

11. The device of claim 1 wherein said light source comprises an LED.

12. The device of claim 1 wherein light emanating from said light source is focused onto said substantially transparent side wall.

13. The combination of a beverage container and a device for illuminating the beverage container, said beverage container having a substantially transparent side wall, a base and an indent configured within said base, said device comprising a light source and a power supply for activating said light source, said device sized to reside on or in said base, said light source positioned to cause said indent to be illuminated to such an extent that said illumination is visible through said substantially transparent side wall.

14. The combination of claim 13 comprising a plurality of beverage containers, each in combination with a device for their illumination.

15. The combination of claim 14 wherein said plurality of containers are distinguishable from one another by associating each with a distinguishable source of illumination.

16. The combination of claim 13 further comprising a platform configured to house said light source and power supply and to support said beverage container by receiving said base.

17. The combination of claim 13 wherein said light source and power supply are sized to reside entirely within said indent.

18. The combination of claim 17 further comprising an adhesive for retaining said device within said indent.

19. The combination of claim 13 wherein said power supply comprises a battery.

20. The combination of claim 13 wherein said power supply comprises an AC source.

21. The combination of claim 13 wherein said light source is in constant illumination when connected to said power supply.

22. The combination of claim 13 wherein said light source pulses when connected to said power supply.

23. The combination of claim 13 wherein said light source comprises an LED.

24. A device for illuminating a beverage container, said beverage container having a substantially transparent side wall, a base and indent configured within said base, said device comprising a light source and power supply for activating said light source, said device sized to reside within said indent causing said indent to be illuminated to such an extent that said illumination is visible through said substantially transparent side wall.

25. The device of claim 24 wherein said light source and power supply are situated in a thin film.

26. The device of claim 24 wherein said light source is an LED.

27. The device of claim 24 wherein said device further comprises an adhesive for attaching said device to said indent.
